(19) United States
(12) Patent Application Publication
(10) Pub. No.: US 2026/0288316 A1
(43) Pub. Date: Sep. 24, 2026

(54) SELECTIVE CONTENT RECORDING

(71) Applicant: Adobe Inc., San Jose, CA (US)

(72) Inventor: Haridoss R, Bangalore (IN)

(73) Assignee: Adobe Inc., San Jose, CA (US)

(21) Appl. No.: 19/086,773

(22) Filed: Mar. 21, 2025

(51) Int. Cl. G06F 3/04845; G06F 3/0482

(52) U.S. Cl. CPC G06F 3/04845; G06F 3/0482

(57) ABSTRACT

Selective content recording is described. A web-based recording system leverages web application programming interfaces (APIs) to capture and synchronize multiple media streams simultaneously, including display content (e.g., application windows, browser tabs, and so forth) and user content (e.g., audio and video capturing a computing device user). The recording system operates within a web browser environment, eliminating the need for platform-specific installations or updates, and captures only portions of display content and portions of user content that are explicitly selected by a user. Selected portions of display media and selected portions of user media are rendered as separate elements on a single canvas, enabling real-time merging of different media streams via a web browser in a platform-agnostic manner.

### BACKGROUND

Screen recording and video capture technologies have become essential tools for content creators, educators, and professionals to share information, demonstrate processes, and engage with audiences across digital platforms. As demand for visual content continues to grow, there is an increasing need for accessible, user-friendly solutions that enable efficient creation of high-quality recordings of digital content. Conventional approaches to screen recording often require specialized software installations, are limited by hardware platform dependencies, or lack flexibility to capture specific application windows while simultaneously integrating webcam feeds. These conventional limitations impede content creators' ability to produce polished, professional-looking recordings quickly and easily, particularly when working across different devices or operating systems.

### SUMMARY

Selective content recording techniques are described that address technical challenges facing conventional screen recording approaches. A web-based recording system leverages web application programming interfaces (APIs) to capture and synchronize multiple media streams simultaneously, including display content (e.g., application windows, browser tabs, desktop screen etc.) and user content (e.g., webcam audio and video). The recording system operates within a web browser environment, eliminating the need for platform-specific installations or updates, and captures only content explicitly selected by a user.

The recording system renders display media and user media as separate elements on a single canvas, enabling real-time merging of different media streams via a web browser. This approach provides users with precise control over the layout and appearance of their recordings while reducing computational overhead. The system aligns audio associated with both display content and user content to ensure proper synchronization during playback.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ selective content recording techniques described herein.

FIG. 2 depicts a system in an example implementation showing operation of the recording system of FIG. 1 in greater detail as generating composite recording based on a recording request.

FIG. 3 depicts a system in an example implementation showing output of a user interface used to define user media and display media to be included in a composite recording generated by the recording system of FIG. 1.

FIG. 4 depicts a system in an example implementation showing output of a user interface used to define display media to be included in a composite recording generated by the recording system of FIG. 1.

FIG. 5 depicts a system in an example implementation showing output of a user interface used to define layout constraints for user media and display media included in a composite recording generated by the recording system of FIG. 1.

FIG. 6 depicts a system in an example implementation showing output of a user interface used to define layout constraints for user media included in a composite recording generated by the recording system of FIG. 1.

FIG. 7 depicts a system in an example implementation showing output of a composite recording generated by the recording system of FIG. 1.

FIG. 8 depicts a procedure in an example implementation of selective content recording.

FIG. 9 illustrates an example system including various components of an example device that can be implemented as any type of computing device as described and/or utilize with reference to the previous figures to implement the techniques described herein.

### DETAILED DESCRIPTION

### Overview

Conventionally, generating screen recordings with integrated webcam video and audio requires either installing specialized software on a user's device or using browser-based tools offering limited functionality. Screen recording applications downloaded to a user's device, however, often suffer from platform dependencies, requiring separate installations for different operating systems, regular updates, and so forth. Thus, conventional screen recording applications consume significant storage space and processing power on a user's device, limiting accessibility across various platforms. Conventional browser-based screen recorders generally lack the ability to isolate specific application windows or browser tabs for recording, often capturing an entire screen, which can lead to privacy concerns and unwanted content being included in a final recording.

These conventional approaches to generating screen recordings, both via installed applications and browser-based, face challenges in providing seamless integration of user content (e.g., webcam video and audio) with screen captures. For instance, conventional approaches fail to offer real-time customization user content display constraints (e.g., webcam overlay positioning and size) within the recorded content. As a further drawback, synchronization between video and audio streams is problematic for conventional techniques, especially in browser-based solutions, often requiring additional configuration or software to achieve proper alignment. The encoding and processing of video and audio streams in real-time also presents challenges, particularly for browser-based tools, which may result in reduced video quality or increased resource consumption on a user's device.

To address these technical shortcomings, selective content recording is described. The selective content recording techniques described herein provide a web-based platform for synchronized recording of display content output by a computing device (e.g., audio data and image data output by one or more application windows, one or more browser tabs, combinations thereof, and so forth) and user content (e.g., audio data and/or image data capturing a user) captured by the computing device. To do so, the described techniques leverage web-based APIs to initialize and capture multiple media streams simultaneously. For instance, in implementations a first API is leveraged to capture a specific application window or browser tab and a second API is leveraged to capture a webcam stream. By utilizing such APIS, the described techniques enable a user's computing device to control generation of a composite recording by a recording system that operates within a web-browser environment, eliminating the need for platform-specific installations or updates. Advantageously, the APIs are configured to capture only explicitly selected content (e.g., user-specified display content and/or user content), such that other content is not included in a recording, even in scenarios where other content is displayed concurrently with selected display content during the recording.

In some implementations, the composite recording of specified display media and user media involves rendering display media and user media as separate Hypertext Markup Language 5 (“HTML5”) elements on a single HTML5 canvas. In this manner, the described techniques enable merging different media streams in real-time via a web browser. In some implementations, one or more elements representing display media are rendered to bias filling the canvas with display media, while an element representing the user content is merged into a single layer with the display media element(s) based on location constraints (e.g., a defined position and scale). This real-time canvas merging approach provides users with precise control over the layout and appearance of their recordings, which is not possible using conventional screen recording approaches. As a further advantage relative to conventional screen recording approaches, the described techniques reduce computational overhead (e.g., consumption of computational resources such as processing power, memory, communication bandwidth, and so forth) that would otherwise be required by a computing device locally generating a recording.

In addition to cohesively combining visual display content and visual user content for seamless recording playback, the described techniques align audio associated with both the display content and the user content to ensure that audio and video remain properly synchronized during playback of the recording. This audio and video data synchronization results in improved recording generation relative to conventional recording systems, particularly browser-based recording systems, which struggle to maintain audio-video synchronization without relying on additional software installed at a client computing device.

The described techniques advantageously consider data handling and encoding during the recording generation process to generate high-quality recordings for a defined format in a manner that optimizes recording quality and a file size of the recording. For instance, in some implementations a recording is generated in a WebM format to generate high-quality video data that can be efficiently stored and transmitted among different computing devices. As a further benefit not realized by conventional approaches, the described techniques enable for recording generation in a web browser environment to allow immediate download of the recording without intermediate processing steps, such as exporting raw recorded data from a browser to a local storage location, using separate applications to capture and combine media streams, post-processing to adjust video quality or reduce file size, running a separate encoding to generate a defined-format recording, and so forth.

The described techniques thus offer advantages over conventional approaches by providing a comprehensive, browser-based solution for synchronized user content and display content recording, where unselected content is excluded from the recording. In contrast to conventional applications and limited browser-based tools, the described techniques leverage web-based APIs and HTML5 capabilities to deliver a seamless, platform-agnostic recording experience. The real-time merging of multiple media streams on a canvas, coupled with optimized encoding and audio synchronization, enables the creation of high-quality, customizable recordings without the need for software installation or platform-specific adaptations. This not only enhances accessibility and ease of use across different devices but also addresses privacy concerns facing conventional systems that fail to enable isolated content recording. Furthermore, the efficient use of browser resources and optimized output format ensures a smooth recording process and manageable file sizes, overcoming limitations of conventional solutions. These technical advancements result in a more versatile, efficient, and user-friendly screen recording process that conventional methods cannot achieve. Further discussion of these and other examples is included in the following discussion and shown in corresponding figures.

In the following description, an example environment is described that employs the techniques described herein. Example procedures are also described that are performable in the example environment as well as other environments. Consequently, performance of the example procedures is not limited to the example environment and the example environment is not limited to performance of the example procedures.

### Example Selective Content Recording Environment

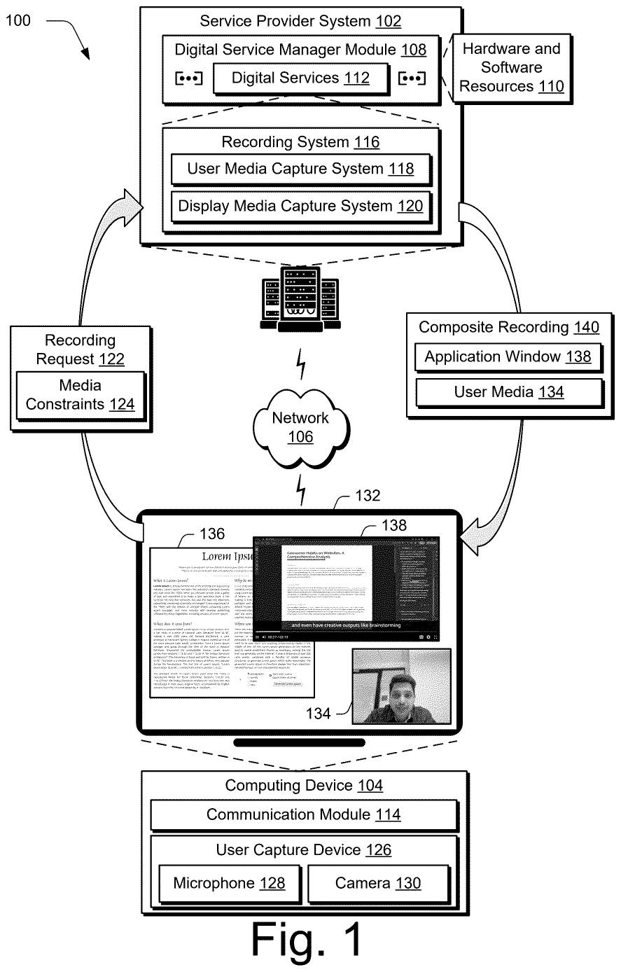

FIG. 1 is an illustration of a digital medium environment 100 in an example implementation that is operable to employ the selective content recording techniques described herein. The illustrated environment 100 includes a service provider system 102 and a computing device 104 that are communicatively coupled, one to another, via a network 106. Computing devices are configurable in a variety of ways.

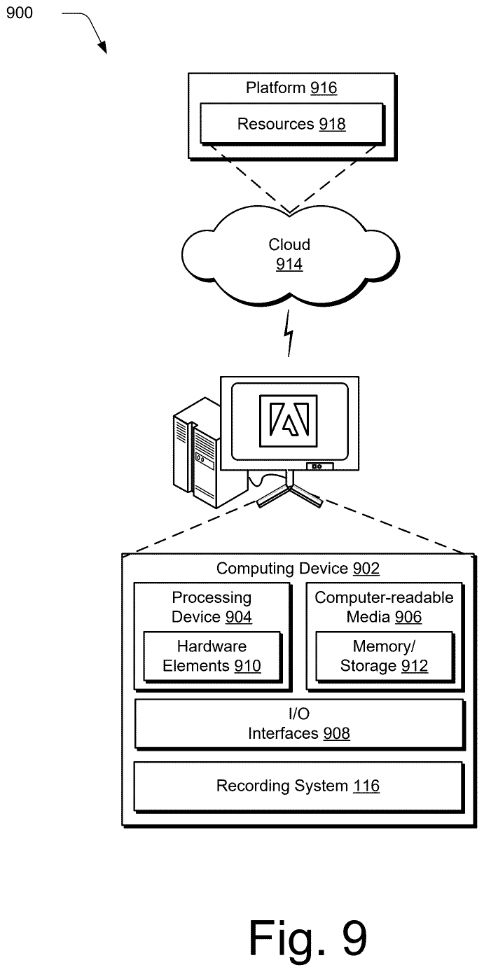

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized to perform operations “over the cloud” for the service provider system 102 and as further described in relation to FIG. 9.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices (e.g., computing device 104).

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a recording system 116. The recording system 116 includes a user media capture system 118 and a display media capture system 120. As described in further detail below, the user media capture system 118 represents functionality of the recording system 116 to capture content related to a user of the computing device 104, such as audio of the user, video of the user, or combinations thereof. This may include, for instance, recording the user's voice via a microphone or capturing video of the user via a webcam. The display media capture system 120 represents functionality of the recording system 116 to capture selected portions of content output by the computing device 104. This can include recording specific application windows, individual browser tabs, locally stored digital content, or combinations thereof, output by the computing device 104. As described in further detail below, the user media capture system 118 and the display media capture system 120 are configurable for selective recording of display media as well as selective recording of user media.

The recording system 116 is configured to receive a recording request 122 which is defined by one or more media constraints 124. The recording request 122 is a user-initiated (e.g., at the computing device 104) command that instructs the recording system 116 to begin capturing media content and generating a composite recording that includes the captured media content. In implementations, the recording request 122 is triggered via one or more user interface elements presented by the communication module 114, such as a button click, a voice command, or gesture, depending on the implementation of the recording system 116.

The one or more media constraints 124 are parameters that define the scope and characteristics of the recording to be generated. These constraints specify not only the display media to be included in the recording, but also the user media to be captured and incorporated in the composite recording. For display media, the media constraints 124 are configurable to specify one or more particular application windows, one or more browser tabs, one or more regions of a screen, combinations thereof, and so forth, to be captured in the composite recording. For user media, the media constraints are configurable to define at least one user capture device 126 that should be utilized and how output of the at least one user capture device 126 should be integrated into the composite recording.

The user capture device 126 is representative of various input peripherals capable of capturing user-generated content. Examples of user capture devices 126 include, but are not limited to, a microphone 128 for capturing audio input and a camera 130 for capturing video or still images of the user. The media constraints 124 are configurable to specify which of these devices should be used to capture data for inclusion in the composite recording. Alternatively or additionally, the media constraints 124 are configurable to include parameters for a user capture device 126, such as audio quality, video resolution, frame rate, and so forth.

In some implementations, the media constraints 124 may also define the layout and composition of the final recording, such as the position and size of a user video overlay relative to captured display media content. Alternatively or additionally, the media constraints 124 specify audio mixing preferences, such as relative volume levels of system audio (e.g., display media content audio) and user-generated audio (e.g., user media content audio) in the final composite recording.

In the illustrated example of FIG. 1, computing device 104 is configured to output digital content via user interface 132. The user interface 132 represents a visual display presented to the user of the computing device 104 and is further representative of one or more audio output devices of the computing device 104. In the illustrated example of FIG. 1, user interface 132 includes a display of user media 134, application window 136, and browser tab 138. The user media 134 is representative of audio captured by the microphone 128 and video captured by the camera 130. Thus, user media 134 represents a webcam feed capturing (e.g., audibly and visually) the user of the computing device 104.

In the illustrated example of FIG. 1, the user interface 132 depicts a scenario where a user of the computing device 104 is delivering a presentation to other users via computing devices connected through the network 106. For instance, the application window 136 represents a dedicated window that includes a script for the user's presentation (e.g., a script that allows the presenter to reference prepared content during the presentation but is not intended to be shared with others during the presentation).

Conversely, the browser tab 138 represents content that is intended to be shared with others during the presentation (e.g., a video that conveys the subject matter of the presentation, serving as a visual aid to complement the user's spoken content). In the context of the user interface 132, some conventional recording approaches require capturing the entire user interface 132, including the user media 134, application window 136, and browser tab 138, regardless of the user's intent to share only specific portions of the content. Alternatively, other conventional recording approaches enable capturing only browser tab 138 without inclusion of the user media 134.

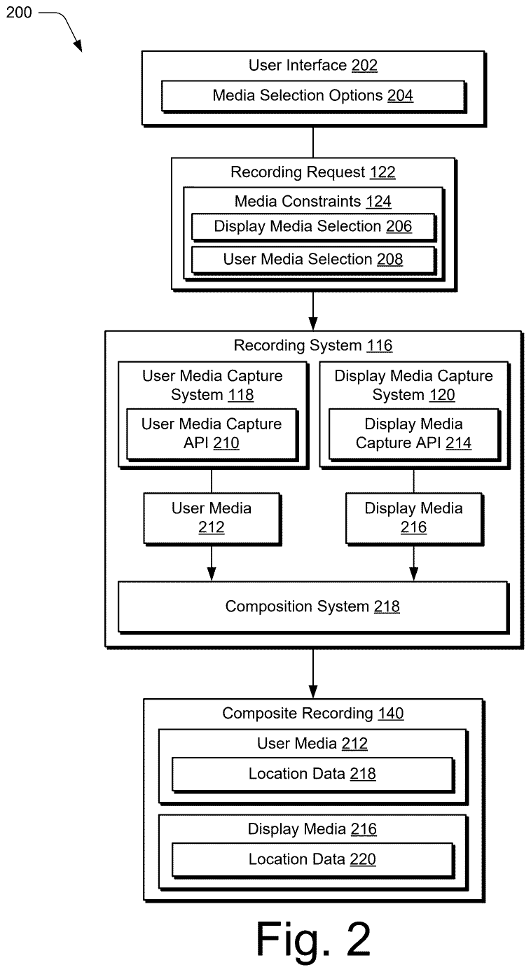

In contrast to such conventional recording approaches, the media constraints 124 of the recording request 122 enable users to precisely specify which elements of the user interface 132 should be included in a composite recording. This approach allows for the isolation of browser tab 138, without capturing application window 136, while also capturing user media 134. For instance, the illustrated example of FIG. 1 depicts a scenario where the recording request 122 causes the recording system 116 to generate composite recording 140, where composite recording 140 includes browser tab 138 and user media 134, while excluding application window 136 and other content output by the user interface 132. This granular control over recorded content enhances privacy, improves the focus and quality of the final recording, and provides users with a more versatile and efficient recording experience. For a further description of the recording system 116 generating composite recording 140 based on media constraints 124 of a recording request 122, consider FIG. 2.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Selective Content Recording

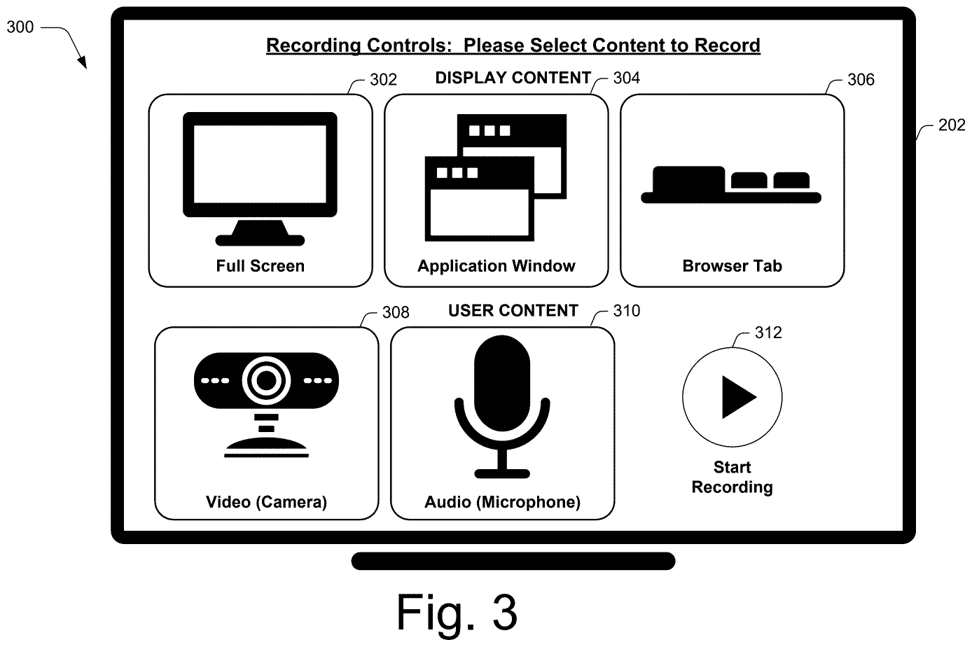

FIG. 2 depicts a system 200 in an example implementation showing operation of the recording system 116 of FIG. 1 in greater detail as generating composite recording 140 based on a recording request 122. In the illustrated example of FIG. 2, the recording request 122 is generated based on input received at user interface 202, which includes one or more media selection options 204. In implementations, the user interface 202 is representative of a user interface output at the computing device 104 via communication module 114. Further examples of the user interface 202 are described below with respect to FIGS. 3-6. Although depicted in the illustrated example of FIG. 1 as being implemented at the service provider system 102, in some implementations functionality of the recording system 116 is executed locally at the computing device 104 (e.g., by retrieving executable instructions of the recording system 116 via the communication module 114 and using hardware resources of the computing device 104 to execute the retrieved instructions).

The recording request 122 includes media constraints 124, which comprise a display media selection 206 and a user media selection 208. Display media selection 206 and a user media selection 208 specify parameters for generating the composite recording 140, defining which specific elements of display media and user media should be captured.

The recording system 116 processes the recording request 122 using a media capture system 118 and a display media capture system 120. The user media capture system 118 leverages a user media capture API 210 to capture user media 212 as defined by the media constraints 124. In one or more implementations, the user media capture API 210 is the getUserMedia API, which allows access to user media devices such as camera 130 and microphone 128. In this manner, the recording system 116 identifies user content being output by the computing device 104 via a browser-based API and independent of (e.g., without) requiring application software to be downloaded on the computing device 104. The user media capture system 118 applies the constraints specified in the user media selection 208 to determine which user media streams to capture and how to configure captured user media in the composite recording 140.

Similarly, the display media capture system 120 uses a display media capture API 214 to capture display media 216 as defined by media constraints 124. In one or more implementations, the display media capture API 214 is the getDisplayMedia API, which enables capture of only specified display content such as application windows or browser tabs. In this manner, the recording system 116 identifies display content being output by the computing device 104 via a browser-based API and independent of (e.g., without) requiring application software to be downloaded on the computing device 104. The display media capture system 120 applies the constraints specified in the display media selection 206 to determine which portions of the display to capture and how to configure captured display media in the composite recording 140.

Composition system 218 represents functionality of the recording system 116 to generate the composite recording 140 by rendering the user media 212 and display media 216 into a single display layer. In one or more implementations, this rendering is accomplished by creating separate HTML5 elements for the user media 212 and display media 216 on a single HTML5 canvas. The composition system 218 positions HTML5 elements according to the media constraints 124. For instance, the composition system 218 positions user media 212 in the composite recording 140 according to location data 220 and positions display media 216 in the composite recording 140 according to location data 222. In implementations, location data 220 and location data 222 respectively define position information for the user media 212 and the display media 216 based on media constraints 124 defined via input to one or more media selection options 204. For a further description of generating the composite recording 140 based on input received at the user interface 202, consider FIGS. 3-6.

FIG. 3 depicts a system 300 in an example implementation showing output of a user interface used to define user media and display media to be included in a composite recording generated by the recording system of FIG. 1. In the illustrated example of FIG. 3, user interface 202 includes multiple display content options and user content options for configuring media constraints 124 included as part of a recording request 122. Specifically, the user interface 202 includes display content option 302, which is selectable to generate a recording request 122 for generating a full screen recording (e.g., a composite recording 140 that depicts an entirety of user interface 132). Additionally, the user interface 202 includes display content option 304, which is selectable to generate a recording request 122 that includes one or more specified application windows (e.g., a subset of display content output at the computing device 104) and thus exclude unselected application windows from inclusion in the composite recording 140. The user interface 202 further includes display content option 306, which is selectable to generate a recording request 122 that includes one or more specified browser tabs (and thus exclude unselected browser tabs, browser chrome such as controls, address bars, and so forth from inclusion in the composite recording 140). Each of the display content options depicted in FIG. 3 represent examples of media selection options 204 offered by the user interface 202.

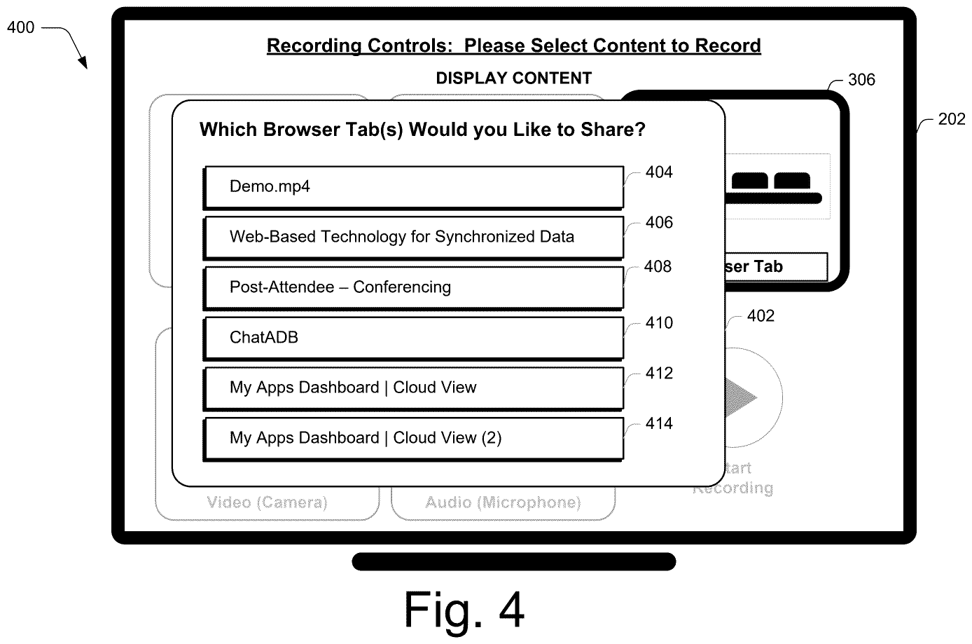

In addition to including media selection options 204 for selecting display media, the user interface 202 includes media selection options 204 for selecting user media to be included in the composite recording 140. For instance, the illustrated example of FIG. 4 includes user content option 308, which is selectable to generate a recording request 122 that causes at least one of audio or video captured by the camera 130 to be included in the composite recording 140. Similarly, user interface 202 includes user content option 310, which is selectable to generate a recording request 122 that causes audio captured by microphone 128 to be included in the composite recording 140. User interface 202 is further configured as including recording control 312 to define time constraints of the composite recording 140. For instance, recording control 312 is selectable to initiate the recording process, by the recording system 116, based on the selected display content and user content options.

The recording control 312 is representative of a dynamic element provided by user interface 202 that that adapts to a current state of the recording process. For instance, in some implementations recording control 312 is initially presented as a “Start Recording” button with a play icon, and thus initiates generation of the composite recording 140 when selected (e.g., via user input at computing device 104). Upon activation, the recording system 116 begins capturing the user media 212 and display media 216 as selected based on the media constraints 124.

As recording commences, the recording control 312 transforms to reflect the active recording state. For instance, in some implementations the play icon changes to a pause button, allowing users to temporarily suspend the recording process without terminating it entirely. This pause functionality offered by recording control 312 enables users to make adjustments or prepare for the next segment of their recording. In some implementations, pausing enables a user to define new media constraints 124, such that different selections of user media 212, different selections of display media 216, or combinations thereof, are output during different portions during playback of the composite recording 140. Alternatively or additionally, the recording control 312 is configurable such that a stop button appears alongside the pause button, offering users the option to conclude a recording session.

In some implementations, the recording control 312 incorporates visual indicators such as a recording duration timer or a pulsing red dot to provide real-time feedback on an operational status of the recording system 116. In some implementations, the recording control 312 expands to include additional options during active recording, such as toggling user media on/off, switching between different application windows or browser tabs, adjusting audio levels, and so forth. These dynamic controls enhance a user's ability to create polished, professional recordings by providing granular control over the recording process in real-time.

FIG. 4 depicts a system 400 in an example implementation showing output of a user interface used to define display media to be included in a composite recording generated by the recording system of FIG. 1. In the illustrated example of FIG. 4, the user interface 202 is configured as depicting a browser selection tab interface with a browser tab listing 402. The browser tab listing 402, for instance, is displayed via user interface 202 in response to user input selecting display content option 306 from the user interface depicted in FIG. 3.

Browser tab listing 402 presents multiple browser tabs available for recording, such as a listing of tabs that are currently active via one or more web browsers at the computing device 104. Specifically, in the illustrated example of FIG. 4, the browser tab listing 402 displays browser tab 404, browser tab 406, browser tab 408, browser tab 410, browser tab 412, and browser tab 414 as selectable options for recording. This interface allows users to choose specific browser tabs for inclusion in the recording, providing granular control over the content to be captured.

The browser tab listing 402 thus represents a configuration of user interface 202 for selecting one or more browser tabs to be included in the composite recording 140. When a user selects an individual browser tab from the listing, such as browser tab 404, browser tab 406, or any other displayed tab, the communication module 114 generates corresponding media constraints 124 that define the specific display content to be captured.

Upon selection of one or more browser tabs, the media constraints 124 are configured to instruct the recording system 116 to render each selected browser tab as an individual element on a common canvas. In one or more implementations, this rendering process involves creating separate HTML5 elements for each selected browser tab on a single HTML5 canvas.

For example, if a user selects browser tab 404 and browser tab 408, the recording system 116 generates two distinct HTML5 elements, each representing the content of its respective selected tab. These elements are then positioned on the HTML5 canvas according to the layout specifications defined in the media constraints 124. This approach allows for precise control over the arrangement and presentation of multiple browser tabs within the composite recording 140.

The recording system 116 continuously captures the content of each selected browser tab as separate streams, maintaining their individual integrity while combining them into a cohesive recording. This enables users to create sophisticated recordings that incorporate content from multiple browser tabs, each rendered as a distinct element within the final composition.

Furthermore, the use of HTML5 elements on a common canvas facilitates dynamic adjustments during the recording process. Users can potentially modify the layout, size, or position of individual browser tab elements in real-time, providing flexibility in the creation of the composite recording 140. This granular control over individual browser tab elements enhances the versatility of the recording system 116, allowing for the creation of highly customized and professional-looking recordings that precisely capture the desired content from multiple browser tabs.

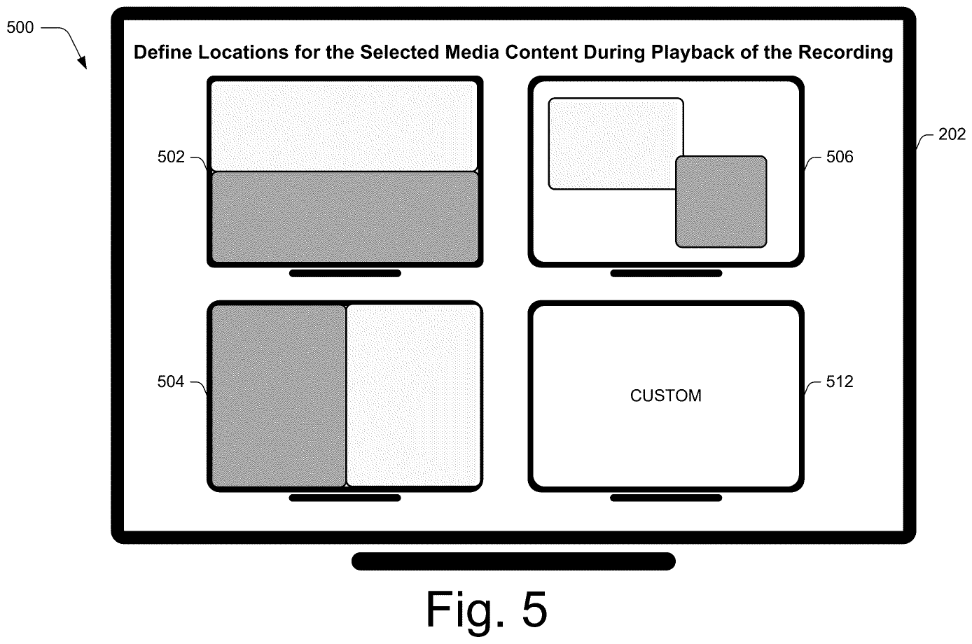

The user interface depicted in FIG. 4 is further configurable to display individual application windows for selection in a manner similar to the browser tab listing 402. In response to user input selecting display content option 304 from the interface shown in FIG. 3, the user interface 202 adapts to present an application window listing. This listing displays multiple active application windows on the computing device 104 as selectable options for recording. The application window listing enables users to choose specific application windows for inclusion in the composite recording 140, providing the same level of granular control over content selection as offered for browser tabs. This flexibility allows users to precisely define which application windows should be captured, excluding undesired content from other windows or applications running on the computing device 104. For a further description regarding how media constraints 124 are configurable to define a layout of different elements in the composite recording 140, consider FIG. 5.

FIG. 5 depicts a system 500 in an example implementation showing output of a user interface used to define layout constraints for user media and display media included in a composite recording generated by the recording system of FIG. 1. In the illustrated example of FIG. 5, user interface 202 includes a display of multiple recording orientation options for positioning media content elements (e.g., user media 212 and/or API 214) within a recording. The user interface 202 includes a first recording orientation 502 showing a split layout configuration where content can be arranged in vertical sections. A second recording orientation 504 presents another layout option with horizontally divided sections for organizing the recorded content.

The user interface 202 displays a current recording orientation 506 which shows the active layout of selected media content elements as being output at the computing device 104 during the recording. A custom recording orientation 512 is also provided, allowing for user-defined positioning of the content elements within the recording space. For simplicity, FIG. 5 depicts an example scenario where only two media content elements are selected for inclusion in the composite recording 140. However, this illustrated example is not limiting, and the user interface 202 as represented by FIG. 5 is configurable to enable customized display constraints for any number of user media 212 elements, any number of API 214 elements, and combinations thereof.

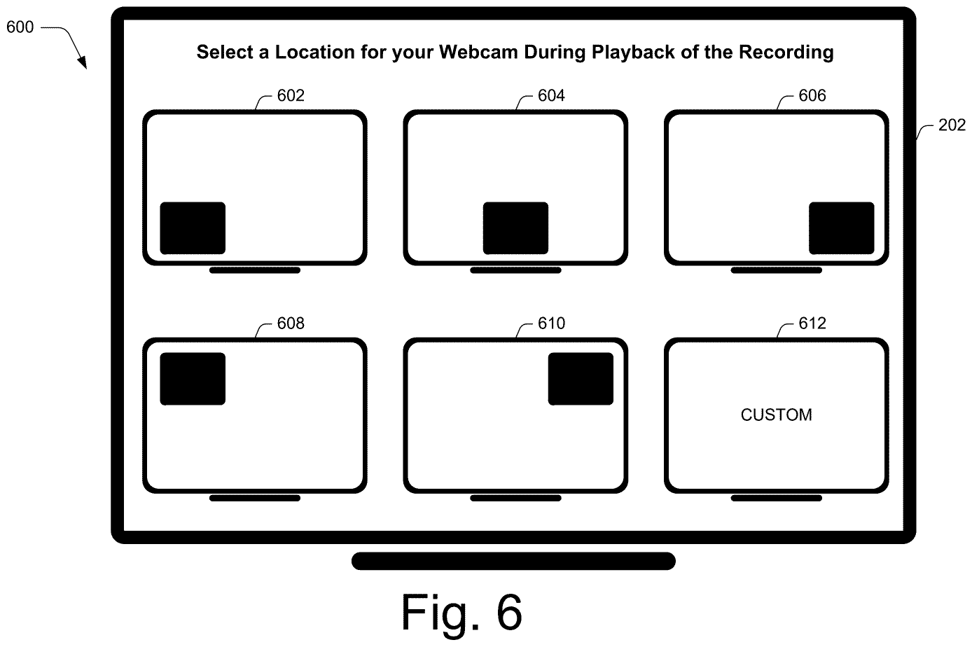

FIG. 6 depicts a system 600 in an example implementation showing output of a user interface used to define layout constraints for user media included in a composite recording generated by the recording system of FIG. 1. For instance, in the illustrated example of FIG. 6, the user interface 202 includes a display of multiple selectable locations for positioning user media 212 (e.g., video captured by camera 130) relative to recorded display media 216. Location 602, location 604, and location 606 show different positioning options in the upper portion of the canvas representing a display area of the composite recording 140. Location 608 and location 610 show additional positioning options in the lower portion of the canvas representing a display area of the composite recording 140. A custom location 612 is also provided, allowing for user-defined positioning of the user media 212. This interface enables users to precisely control the placement of user media within the composite recording.

Each of the user interfaces depicted in FIGS. 3-6 thus represents an example implementation of the user interface 202, with respective interface elements representing different examples of media selection options 204. These interfaces collectively provide a comprehensive set of controls for users to customize their recording experience, from content selection to layout and positioning of various media elements, which is not possible using conventional systems and approaches.

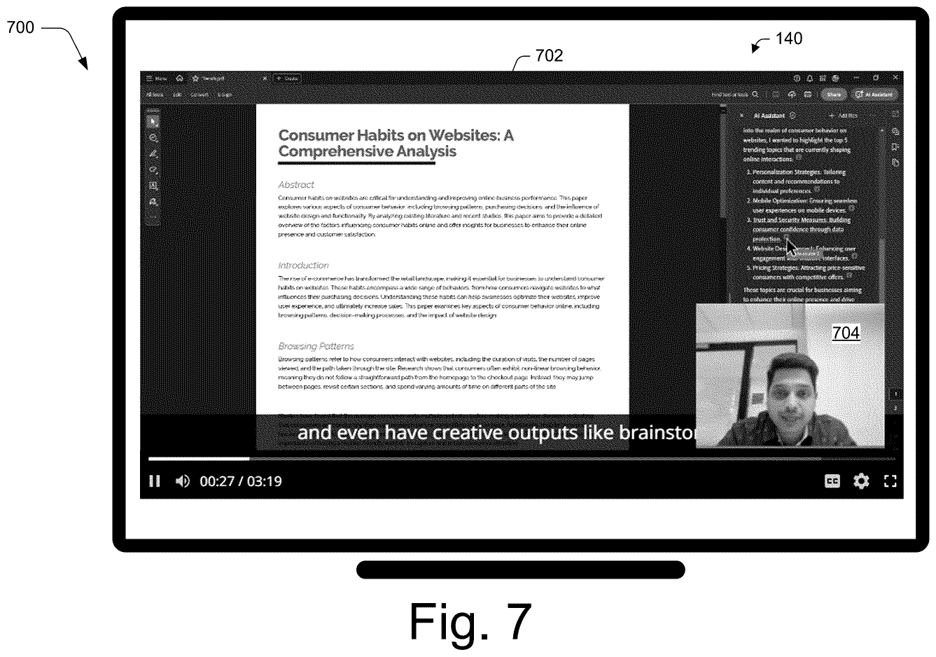

FIG. 7 depicts a system 700 in an example implementation showing output of a composite recording generated by the recording system of FIG. 1. Specifically, the illustrated example of FIG. 7 depicts a composite recording 140 that incudes a combination of display media 702 and user media 704. This example thus depicts a browser-based interface where display media 702 occupies a main portion of the composite recording 140, showing content from a selected source (e.g., application window or browser tab). The user media 704 appears as an overlay positioned in the lower-right portion of the interface, displaying video content captured from a user capture device.

This configuration demonstrates the selective content recording capabilities of the recording system 116, as it enables the generation of a composite recording 140 that includes only the specifically chosen media elements. In this scenario, the display media 702 corresponds to the browser tab 138 illustrated in FIG. 1, which contains the primary content intended for the recording. The user media 704 represents the user media 134 depicted in FIG. 1, which captures the user's video feed.

Notably absent from this composite recording 140 is the application window 136 depicted in FIG. 1, which includes content output by the computing device 104 during generation of the composite recording 140 and is not intended for inclusion in the composite recording 140. This exclusion highlights the ability of the recording system 116 to selectively capture and combine only desired user media 212 and or display media 216 elements, without requiring installation of application software on the computing device 104, which is not possible using conventional recording systems.

The layout of the composite recording 140 as shown in FIG. 7 illustrates how the recording system 116 integrates media streams as selected by the media constraints 124 in the recording request 122. The display media 702 forms the background or main content area, while the user media 704 is overlaid (e.g., similar to a picture-in-picture format appearance). This arrangement allows viewers to simultaneously view the presented content and the presenter, creating a more engaging and informative recording.

The positioning of the user media 704 demonstrates how the recording system 116 applies location constraints as defined in the media constraints 124 to precisely control relative positioning and sizing of content during playback of the composite recording 140. This composite view demonstrates capability of the recording system 116 to create professional recordings that combine multiple media sources seamlessly. By leveraging web-based APIs and HTML5 canvas rendering, the recording system 116 produces a unified output that maintains the quality and integrity of both the display content and the user's video feed, all while excluding undesired elements from the composite recording 140. The recording system 116 is thus configured to output the composite recording 140 for storage and/or playback via one or more computing devices, such as via computing device 104, or one or more additional computing devices communicatively coupled to the recording system 116 (e.g., via network 106).

Having considered example systems and techniques for selective content recording, consider now example procedures to illustrate aspects of the techniques described herein.

### Example Procedures

The following discussion describes selective content recording techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following description, reference is made to FIGS. 1-7.

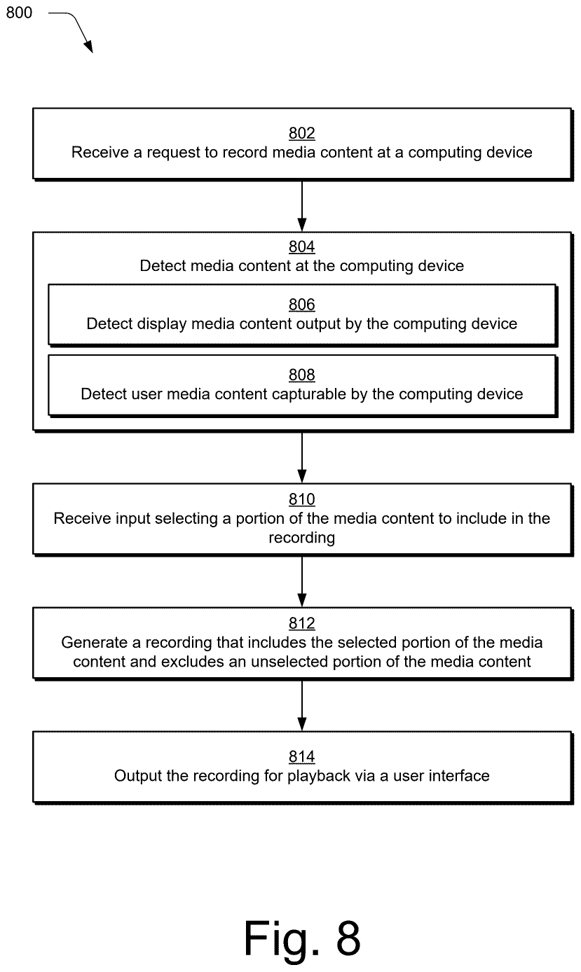

FIG. 8 depicts a procedure 800 in an example implementation of selective content recording. To begin, a request to record media content at a computing device is received (block 802). The recording system 116, for instance, receives a recording request 122 which is defined by one or more media constraints 124. The recording request 122 may be triggered via one or more user interface elements presented by the communication module 114, such as the recording control 312 shown in FIG. 3.

Media content at the computing device is then detected (block 804). This detection process involves two sub-steps: detecting display media content output by the computing device (block 806) and detecting user media content capturable by the computing device (block 808). The display media capture system 120, for example, detects display media 216 using API 214 (e.g., application windows 136 or browser tabs 138 as shown in FIG. 1). Concurrently, the user media capture system 118 detects user media 212 that can be captured by user capture devices 126 using API 210 (e.g., microphone 128 and camera 130).

Input selecting a portion of the media content to include in the recording is then received (block 810). For instance, input is received via user interface 202, which presents media selection options 204 as illustrated in FIGS. 3-6. For instance, a user may select specific browser tabs from the browser tab listing 402 shown in FIG. 4, choose a webcam location as depicted in FIG. 6, combinations thereof, and so forth.

Based on the received input, a recording is generated that includes the selected portion of the media content and excludes an unselected portion of the media content (block 812). The composition system 218 combines the selected display media 216 and user media 212 into a composite recording 140. This process may involve rendering separate HTML5 elements on an HTML5 canvas, as described in relation to FIG. 2.

Finally, the recording is output for playback via a user interface (block 814). The resulting composite recording 140 is made available for playback (e.g., as depicted in FIG. 7, where display media 702 and user media 704 are combined in a single interface) excluding any unselected content (e.g., application window 136 from FIG. 1).

Having described example procedures in accordance with one or more implementations, consider now an example system and device to implement the various techniques described herein.

### Example System and Device

FIG. 9 illustrates an example system 900 that includes an example computing device 902 that is representative of one or more computing systems and/or devices that implement the various techniques described herein. This is illustrated through inclusion of the recording system 116. The computing device 902 is configurable, for example, as a server of a service provider, a device associated with a client (e.g., a client device), an on-chip system, and/or any other suitable computing device or computing system.

The example computing device 902 as illustrated includes a processing device 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 904 is representative of functionality to perform one or more operations using hardware. Accordingly, the processing device 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 906 is illustrated as including memory/storage 912 that stores instructions that are executable to cause the processing device 904 to perform operations. The computer-readable storage medium is configured for storing instructions that, responsive to execution by the processing device, causes the processing device to perform operations. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

In implementations, the platform 916 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving a request to generate a recording of digital content;
receiving data defining a portion of display content output by a computing device and user content capturable via the computing device for inclusion in the recording;
generating the recording to include the portion of display content and the user content, the recording excluding display content other than the portion of display content; and
outputting the recording for playback via a user interface.

2. The method of claim 1, further comprising:
identifying the display content output by the computing device;
presenting a selection interface that includes a plurality of selectable options, each of the plurality of selectable options corresponding to a different portion of the display content output by the computing device; and
detecting input selecting at least one of the plurality of selectable options, wherein the data defining the portion of display content output by the computing device is generated based on the input selecting the at least one of the plurality of selectable options.

3. The method of claim 2, wherein identifying the display content output by the computing device is performed using an application programming interface (API) to capture display content output by at least one output device communicatively coupled to the computing device.

4. The method of claim 1, further comprising:
identifying the user content capturable via the computing device;
presenting a selection interface that includes a plurality of selectable options, each of the plurality of selectable options corresponding to a different input device of the computing device; and
detecting input selecting at least one of the plurality of selectable options, wherein the data defining the user content capturable via the computing device for inclusion in the recording is generated based on the input selecting the at least one of the plurality of selectable options.

5. The method of claim 4, wherein identifying the user content capturable via the computing device is performed using an API to capture audio and video of a user of the computing device.

6. The method of claim 1, wherein the portion of display content comprises one or more application windows.

7. The method of claim 1, wherein the portion of display content comprises one or more web browser tabs.

8. The method of claim 1, wherein the user content comprises image data that is capturable by a camera of the computing device, the method further comprising displaying options for positioning the image data during playback of the recording, wherein generating the recording comprises positioning the image data corresponding to one of the options for positioning the image data during playback of the recording.

9. The method of claim 1, wherein generating the recording is performed independent of downloading application software at the computing device.

10. The method of claim 1, further comprising connecting the computing device to a recording system via a web browser, wherein receiving the request to generate the recording of digital content, receiving the data defining the portion of display content and the user content capturable via the computing device for inclusion in the recording, and outputting the recording for playback via the user interface are performed by the recording system via the web browser.

11. The method of claim 1, wherein generating the recording comprises combining the portion of the display content and the user content into a single display layer.

12. The method of claim 11, wherein generating the recording comprises combining the portion of the display content and the user content as Hypertext Markup Language 5 (“HTML5”) elements on a HTML5 canvas.

13. A system comprising:
one or more processors; and
a computer-readable storage medium storing instructions that are executable by the one or more processors to perform operations comprising:
outputting display content selection options that each correspond to a different portion of display content output at a computing device;
outputting user content selection options that each correspond to a different input device that captures a user of the computing device;
receiving user input selecting at least one of the display content selection options and at least one of the user content selection options;
causing a recording system to generate a recording that includes a subset of the display content and user content captured by at least one input device of the computing device; and
outputting the recording for display via a user interface.

14. The system of claim 13, wherein causing the recording system to generate the recording is performed by interfacing, by the computing device, with the recording system via a web browser.

15. The system of claim 13, wherein causing the recording system to generate the recording is performed independent of downloading application software at the computing device.

16. The system of claim 13, wherein causing the recording system to generate the recording comprises causing the recording system to render the subset of the display content output at the computing device as a first Hypertext Markup Language 5 (“HTML5”) element and render the user content captured by the at least one input device as a second HTML5 element on an HTML5 canvas.

17. The system of claim 13, wherein the user content comprises image data that is capturable by a camera of the computing device, the operations further comprising:
outputting an interface that includes options for positioning the image data during playback of the recording;
receiving input defining location constraints for positioning the image data during playback of the recording; and
causing the recording system to position the image data in the recording based on the location constraints.

18. The system of claim 13, wherein the display content output at the computing device comprises a plurality of application windows and the subset of the display content comprises a proper subset of the plurality of application windows.

19. The system of claim 13, wherein the display content output at the computing device comprises a plurality of web browser tabs and the subset of the display content comprises a proper subset of the plurality of web browser tabs.

20. A computer-readable storage medium storing instructions that are executable by a processing device to perform operations comprising:
receiving a request to generate a recording of digital content;
receiving data defining a portion of display content output by a computing device and user content capturable via the computing device for inclusion in the recording;
generating the recording to include the portion of display content and the user content, the recording excluding display content other than the portion of display content; and
outputting the recording for playback via a user interface.
